(19) United States
(12) Patent Application Publication
(10) Pub. No.: US 2011/0307497 A1
(43) Pub. Date: Dec. 15, 2011

(54) Synthewiser (TM): Document-synthesizing search method

(76) Inventor: Robert A. Connor, Minneapolis, MN (US)

(21) Appl. No.: 12/802,764

(22) Filed: Jun. 14, 2010

(51) Int. Cl. G06F 17/30

(52) U.S. Cl. 707/749; 707/E17.022; 707/E17.084

(57) ABSTRACT

“Synthewiser”™ is a search method and system that synthesizes a single non-template, text-based document that is organized by topic and integrates and consolidates information from multiple sources. This is accomplished by: having a user provide a search phrase; creating seed phrases; identifying seed locations in multiple sources; creating expanded text segments; grouping expanded text segments; consolidating content; and synthesizing a single document. Synthewiser has advantages over today's dominant search engine. Its results are organized by topic and are integrated across multiple sources.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This invention relates to language-based search methods.

2. Review and Limitations of the Prior Art

The prior art includes many methods for searching through multiple text-based sources to find and display those sources that are most relevant to a user's search query. For example, today's dominant internet-based search engine identifies those sources that are most relevant to a user's search query and separately displays selected information concerning each of these sources in a list format. For example, the selected information that is displayed separately for each source may include: source title; snippet of text from the source; and URL (internet address) for the source.

Today's dominant search engine represents a tremendous advance over previous information-finding methods and is extremely useful. However, it has limitations and there is still room for improvement in search engine development. One limitation of today's dominant search engine is the lack of organization of results by topic. Often a user who is interested in a particular topic associated with a search phrase must take the time to scan through a list of sources that jumps around from one topic to another in order to identify those sources concerning the particular topic in which the user is really interested. Alternatively, the user can try to iteratively refine their search phrase to reduce the topic variation in the results list. However, such iteration can also be time consuming. A search method that organizes results by topic could be more useful and efficient for a user than today's dominant search engine that does not organize results by topic.

A second limitation of today's dominant search engine is the lack of integration or consolidation of information across different sources. Often a user who is interested in learning about different aspects of a particular topic has to spend time wading through multiple sources with duplicative material and to manually synthesize relevant information across these multiple sources. A search method that integrates and consolidates information across multiple sources could be more useful and efficient for a user than today's dominant search engine that does not integrate or consolidate information across multiple sources.

Of course, there is more to the prior art than just today's dominant search engine. There is also a wide variety of search methods and systems that have been disclosed in the prior art, but are not in active use. Accordingly, we now conduct a wider review of the different types of search methods in the prior art, including their limitations that will be addressed by the invention disclosed herein.

For this review, we define and discuss six general categories of search methods: (1) Single Source Method—a search method that produces results that are based on a single source; (2) Variable Topic Method—a search method that produces a separate section of text for each source (or for each text segment in a source) from multiple sources, wherein these sections are neither ordered nor clustered by topic; (3) Topic Ordered Method—a search method that produces a separate section of text for each source (or for each text segment in a source) from multiple sources, wherein these sections are ordered or clustered by topic; (4) Template Integrated Method—a search method that produces an integrated template-based document whose predefined fields are filled with information that comes from multiple sources; (5) Topic Integrated Method—a search method that produces a single non-template, text-based document using information from multiple sources, wherein this information is organized by topic; and (6) Fully Integrated Method—a search method that synthesizes a single non-template, text-based document using information from multiple sources, wherein this information is organized by topic and consolidated across multiple sources. There are examples of the first five methods in the prior art, which we now discuss in greater detail.

### 1. Single Source Method

“Single Source Methods” produce results with information from a single source. For example, a method in this category may produce a summary or abstract of single source. As another example, such a method may extract a segment of text from a single source that is particularly relevant to the user's search query. The main limitation of a single source method is that it does not integrate, or even provide in a separate manner, information from multiple sources.

Prior art that appears to use single source methods includes the following U.S. Pat. No. 6,865,572 (Boguraev et al., 2005; “Dynamically Delivering, Displaying Document Content as Encapsulated Within Plurality of Capsule Overviews with Topic Stamp”); U.S. Pat. No. 7,292,972 (Lin et al., 2007; “System and Method for Combining Text Summarization”); U.S. Pat. No. 7,447,683 (Quiroga et al., 2008; “Natural Language Based Search Engine and Methods of Use Therefore”); U.S. Pat. No. 7,512,601 (Cucerzan et al., 2009; “Systems and Methods That Enable Search Engines to Present Relevant Snippets”); and U.S. Pat. No. 7,587,309 (Rohrs et al., 2009; “System and Method for Providing Text Summarization for Use in Web-Based Content”). It also includes the following U.S. Patent Applications: 20090216765 (Dexter et al., 2009; “Systems and Methods of Adaptively Screening Matching Chunks Within Documents”); and 20090216790 (Dexter, 2009; “Systems and Methods of Searching a Document for Relevant Chunks in Response to a Search Request”)

### 2. Variable Topic Method

“Variable Topic Methods” produce results with separate sections of text for each source (or for each text segment in a source) from multiple sources. These sections are neither ordered nor clustered by topic. Also, they are not integrated or consolidate across multiple sources. Today's dominant internet-based search engine would likely be classified as a variable topic method because its result is a list of separate sections (including information such as source title, text snippet, and URL) for each source and this list is neither organized by topic nor integrated across multiple sources. The main limitations of this method are: lack of organization by topic; and lack of integration or consolidation across multiple sources.

Prior art that appears to use variable topic methods includes the following: U.S. Pat. No. 7,587,387 (Hogue, 2009; “User Interface for Facts Query Engine with Snippets from Information Sources that Include Query Terms and Answer Terms”) and U.S. Patent Application 20090313247 (Hogue, 2009; “User Interface for Facts Query Engine with Snippets from Information Sources that Include Query Terms and Answer Terms”).

### 3. Topic Ordered Method

“Topic Ordered Methods” produce results with separate sections of text for each source (or for each text segment in a source) from multiple sources. These are ordered or clustered by topic, but they are neither integrated nor consolidated across multiple sources. Examples of these methods include those that classify, cluster, and/or order sources or text segments by topic or content similarity. The main limitation of this method is the lack of integration and consolidation of information across multiple sources.

Prior art that appears to use topic ordered methods includes the following U.S. Pat. No. 6,542,889 (Aggarwal et al., 2003; “Methods and Apparatus for Similarity Text Search Based on Conceptual Indexing”); U.S. Pat. No. 6,766,316 (Caudill et al., 2004; “Method and System of Ranking and Clustering for Document Indexing and Retrieval”); U.S. Pat. No. 7,062,487 (Nagaishi et al., 2006; “Information Categorizing Method and Apparatus and a Program for Implementing the Method”); U.S. Pat. No. 7,296,009 (Jiang et al., 2007; “Search System”); U.S. Pat. No. 7,401,077 (Bobrow et al., 2008; “Systems and Methods for Using and Constructing User-Interest Sensitive Indicators of Search Results”); U.S. Pat. No. 7,512,605 (Spangler, 2009; “Document Clustering Based on Cohesive Terms”); U.S. Pat. No. 7,536,408 (Patterson, 2009; “Phrase-Based Indexing in an Information Retrieval System”); U.S. Pat. No. 7,574,449 (Majumder, 2009; “Content Matching”); U.S. Pat. No. 7,580,921 (Patterson, 2009; “Phrase Identification in an Information Retrieval System”); U.S. Pat. No. 7,580,929 (Patterson, 2009; “Phrase-Based Personalization of Searches in an Information Retrieval System”); U.S. Pat. No. 7,584,175 (Patterson, 2009; “Phrase-Based Generation of Document Descriptions”); and U.S. Pat. No. 7,599,914 (Patterson, 2009; “Phrase-Based Searching in an Information Retrieval System”). It also includes the following U.S. Patent Applications: 20070043761 (Chim et al., 2007; “Semantic Discovery Engine”); 20090024606(Schilit et al., 2009; “Identifying and Linking Similar Passages in a Digital Text Corpus”); 20090055394 (Schilit et al., 2009; “Identifying Key Terms Related to Similar Passages”); 20090070325 (Gabriel et al., 2009; “Identifying Information Related to a Particular Entity from Electronic Sources”); and 20090240685 (Costello et al., 2009; “Apparatus and Method for Displaying Search Results Using Tabs”).

### 4. Template Integrated Method

“Template Integrated Methods” produce a single template-based document whose predefined fields are filled with information that is extracted from multiple sources. One example of such a method is a report in a standard format whose values are automatically extracted from entries in a database. The main limitations of this method are its inflexibility and limited application to a specialized domain.

Prior art that appears to use template integrated methods includes the following U.S. Pat. No. 7,542,958 (Warren et al., 2009; “Methods for Determining the Similarity of Content and Structuring Unstructured Content from Heterogeneous Sources”); U.S. Pat. No. 7,627,809 (Balinsky, 2009; “Document Creation System and Related Methods”); U.S. Pat. No. 7,689,899 (Leymaster et al., 2010; “Methods and Systems for Generating Documents”); and U.S. Pat. No. 7,721,201 (Grigoriadis et al., 2010; “Automatic Authoring and Publishing System”). It also includes the follow U.S. Patent Applications: 20090292719 (Lachtarnik et al., 2009; “Methods for Automatically Generating Natural-Language News Items from Log Files and Status Traces”); and 20100070448 (Omoigui, 2010; “System and Method for Knowledge Retrieval, Management, Delivery and Presentation”).

### 5. Topic Integrated Method

“Topic Integrated Methods” produce a single non-template, text-based document using information from multiple sources. In these methods, information is organized by topic, but is not fully integrated or consolidated across multiple sources.

One example of this type of method in the prior art is U.S. Pat. No. 7,366,711 (McKeown et al., 2008; “Multi-Document Summarization System and Method”). This method appears to be focused on a particular content domain (a chronological account or news story) wherein the document is structured by phrases that are arranged by time sequence. This method does not appear to be a generalized method that can be used to synthesize a single document from multiple sources in a wide variety of content domains.

A second example of this type of method in the prior art is U.S. Pat. No. 7,548,913 (Ekberg et al., 2009; “Information Synthesis Engine”). This method appears to display material from multiple sources. However, but the material does not appear to be integrated or consolidated across multiple sources. In the examples of output from this method shown in the prior art, content from different sources is displayed in separate sections. In some respects, this output looks like a variation on the lists produced by today's dominant search engine, with the difference being that it displays multiple sentences from each source instead of just a text snippet.

A third example of this type of method in the prior art is U.S. Patent 20090193011 (Blair-Goldensohn et al., 2009; “Phrase Based Snippet Generation”). This method appears to be focused on a particular type of content wherein different sentiments about a product, service, or venue are combined. This method can be useful for creating integrated reviews for a product, service, or venue from different sources, but this method does not appear to be a generalized method of synthesizing a single document from multiple sources for a wide variety of applications.

### 6. Fully Integrated Method

A “Fully Integrated Method” for search would synthesize a single non-template, text-based document using information from multiple sources, wherein this information is organized by topic and is also consolidated across multiple sources. The prior art does not appear to include examples of a fully integrated method for search.

### SUMMARY AND ADVANTAGES OF THIS INVENTION

The invention disclosed herein, called “Synthewiser”™, is the first fully integrated method for search. It is a search method and system that: synthesizes a single non-template, text-based document that is organized by topic; and integrates and consolidates information from multiple sources. This is accomplished in the following steps: (1) having a user provide a search phrase; (2) creating seed phrases, wherein a seed phrase can be the search phrase and also can be a minor variation on the search phrase; (3) identifying seed locations in multiple sources, wherein seed locations are locations where a seed phrase appears; (4) creating expanded text segments, wherein an expanded text segment is created for each seed location and each expanded text segment contains a seed phrase; (5) grouping expanded text segments, wherein expanded text segments are grouped into sets based on content similarity; (6) consolidating content, wherein sets with substantially redundant content are consolidated and wherein expanded text segments, or portions of expanded text segments, with substantially redundant content are consolidated; and (7) synthesizing a single document, wherein this single document has content from some, or all, of these sets of expanded text segments and wherein this content is organized by set.

Synthewiser has two advantages over today's dominant search engine. First, its results are organized by topic. Second, its results are integrated and consolidated across multiple sources. With Synthewiser, a user no longer has to weed through a list of results on a variety of topics or manually synthesize information from multiple sources. We now consider Synthewiser as compared to the full scope of different categories of search methods. Synthewiser is better than single source methods because it integrates information from multiple sources, not just one. Synthewiser is better than variable topic methods because information is organized by topic. Synthewiser is better than topic ordered methods because information is integrated across multiple sources and redundant information is consolidated. Synthewiser is better than template integrated methods because it is sufficiently flexible and generalizable to be used for a wide variety of content domains and applications. Finally, Synthewiser is better than topic integrated methods in the prior art because Synthewiser consolidates information from multiple sources in a manner that is generalizable for use in a wide variety of content domains.

### INTRODUCTION TO THE FIGURES

FIGS. 1 through 8 show an example of how this document-synthesizing search method may be embodied, but they do not limit the full generalizability of the claims.

FIG. 1 provides a flow diagram that shows how this document-synthesizing search method may be embodied.

FIGS. 2 through 8 trace, in actual words, how this method can synthesize a document from multiple sources.

FIG. 2 highlights the first step in this method wherein a user provides a search phrase.

FIG. 3 highlights the second step wherein seed phrases that are the same as, or minor variations of, the search phrase are created.

FIG. 4 highlights the third step wherein seed locations are found across multiple sources.

FIG. 5 highlights the fourth step wherein expanded text segments are created around seed phrases.

FIG. 6 highlights the fifth step wherein expanded text segments are grouped into sets based on content similarity.

FIG. 7 highlights the sixth step wherein sets of expanded text segments may be consolidated and expanded text segments, or portions thereof, may be consolidated within sets.

FIG. 8 highlights the last step that results in the synthesis of a single output document from post-consolidation content.

### DETAILED DESCRIPTION OF THE FIGURES

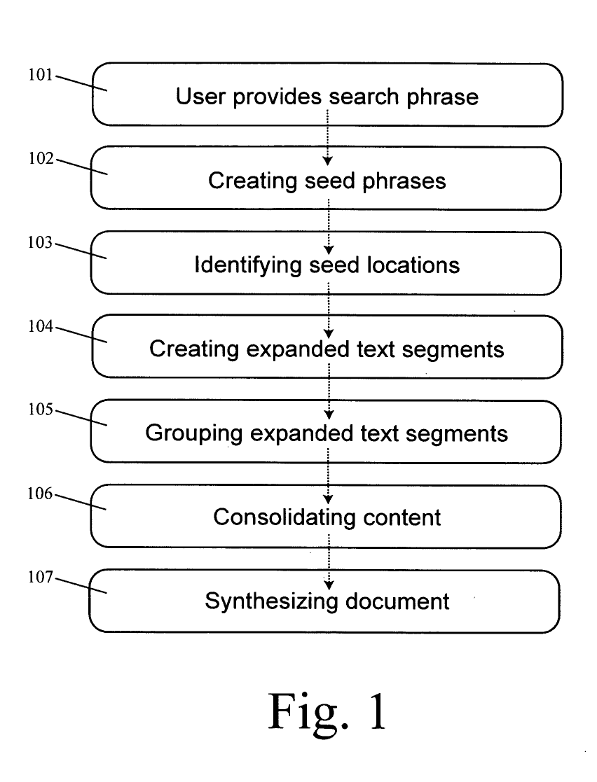

FIGS. 1 through 8 show an example of how this document-synthesizing search method, called Synthewiser™, may be embodied. However, they do not limit the full generalizability of the claims. FIG. 1 provides a flow diagram that shows how this document-synthesizing search method may be embodied in a sequence of seven steps. We start by providing an overview of the flow diagram in FIG. 1. After that, we will provide a detailed discussion of each of the steps in this flow diagram.

By way of overview, the flow diagram in FIG. 1 starts with a text-based search phrase (101) that is provided by a user. This search phrase is ultimately used to produce a single text-based document (107) that is relevant to that search phrase. This single text-based document has organized content that is synthesized from relevant information that comes from multiple text-containing sources. A search method whose output is a single synthesized document with organized content can be more useful for the user than the outputs of current search methods, including outputs such as a discontinuous list of source snippets and links.

We now discuss the steps in the flow diagram in FIG. 1 in detail. The flow diagram representing this embodiment of the method starts with a first step in which a user provides a search phrase (101), as shown at the top of FIG. 1. In an example, the user may provide a text-based search phrase, with one or more words, by typing the search phrase using a keyboard. In an example, this search phrase may be entered into a search box. In other examples, the user may provide a search phrase by: entering a search phrase using a touch screen; selecting a search phrase from a menu of text phrases; selecting a search phrase associated with an icon; selecting a search phrase using a cursor; communicating a search phrase via gesture recognition; or providing a search phrase via speech.

In this example, the method continues with a second step wherein seed phrases are created (102) based on the search phrase. The search phrase itself is one of the seed phrases. Minor variations on the search phrase can also be seed phrases. In various examples, one or more minor variations on the search phrase may be selected from the group consisting of: a phrase with words that are corrected or alternative spelling variations of the words in the search phrase; a phrase with words that are grammatical variations (such as variation in tense, plurality, or voice) of the words comprising the search phrase; a phrase with words that are the same as those comprising the search phrase, except for the addition or deletion of grammatical articles (such as “a” or “an” or “the”) or relatively-neutral modifiers (such as “very” or “especially”); a phrase with words that are the same as those comprising the search phrase, but are in a different word order; a phrase with words that are the same as those comprising the search phrase, except for case variation (such as upper vs. lower case) in one or more letters in the search phrase; a phrase with the same words as those comprising the search phrase, but with variation in punctuation or word contraction; and a phrase that is a phrase synonym for the search phrase, wherein a phrase synonym is defined as alternative phrase that can be substituted for an original phrase in multiple sources without substantively changing meaning or creating a grammatical error in those sources.

The example of the method shown here continues with a third step wherein seed locations (locations where one of the seed phrases appears) are identified throughout multiple text-containing sources (103). In an example, there may be multiple seed locations in a single source. In an example, the sources that are scanned for seed locations may be a subset of a larger body of sources and this subset may be selected from the larger body of sources by a source-ranking algorithm, by human review, or by a combination thereof.

As the next step in the flow diagram representing this example of this method, expanded text segments are created (104). An expanded text segment is created for each seed location and each expanded text segment contains at least one seed phrase. In an example, the expanded text segment may extend backwards in text from the beginning of the seed phrase, may extend forwards in text from the end of the seed phrase, or may extend both backwards and forwards around the seed phrase.

In an example, the expanded text segment may include characters spanning a first location, wherein this first location is a certain number of characters, words, sentences, or paragraphs backwards from the seed phrase, and a second location, wherein this second location is a certain number of characters, words, sentences, or paragraphs forwards from the seed phrase. In another example, the expanded text segment may include characters spanning a first location, wherein this first location expands backwards from the seed phrase until stop criteria based on the length or content of the characters in this backwards expansion are satisfied, and a second location, wherein this second location expands forwards from the seed phrase until stop criteria based on the length or content of the characters in the forwards expansion are satisfied. In another example, the expanded text segment may include characters spanning a first location, wherein this first location expands backwards until one or more key characters or character strings are found, and a second location, wherein this second location expands forwards from the seed phrase until one or more key characters or character strings are found.

In the next step in the flow diagram in FIG. 1, expanded text segments are grouped together into sets of expanded text segments (105) based on similarity of content among the expanded text segments. This step is important for synthesizing a document with organized and structured content. The set structure will also be important for reducing information redundancy in the document. In various examples, this grouping of expanded text segments may be based on: the number of shared words, phrases, or minor variations on word phrases among expanded text segments; the frequencies of shared words, phrases, or minor variations on word phrases among expanded text segments; the percentage of shared words, phrases, or minor variations on word phrases among expanded text segments; the types of shared words, phrases, or minor variations on word phrases among expanded text segments; and/or the order of shared words, phrases, or minor variations on word phrases among expanded text segments.

In other examples, the grouping of expanded text segments into sets may be based on: the number of non-shared words, phrases, or minor variations on word phrases among expanded text segments; the frequencies of non-shared words, phrases, or minor variations on word phrases among expanded text segments; the percentage of non-shared words, phrases, or minor variations on word phrases among expanded text segments; the types of non-shared words, phrases, or minor variations on word phrases among expanded text segments; and/or the order of non-shared words, phrases, or minor variations on word phrases among expanded text segments. In other examples, this grouping may be based on semantic analysis of content similarity among expanded text segments or Bayesian statistical analysis of content similarity among expanded text segments.

The next step in the flow diagram in FIG. 1 involves consolidating content (106). Sets with substantially redundant content are consolidated. In an example, consolidation of sets can involve deleting a set that is substantially redundant or duplicative of another set. In another example, consolidation of sets can involve merging two substantially redundant or duplicative sets together. Also, expanded text segments, or portions of expanded text segments, with substantially redundant content are consolidated. In an example, consolidation of text segments, or portions thereof, can involve deleting a text segment, or portion thereof, that is substantially redundant or duplicative of another text segment, or portion thereof. In another example, consolidation of text segments, or portions thereof, can involve merging two substantially redundant or duplicative text segments, or portions thereof, together.

In various examples, identification of sets, expanded text segments, or portions of expanded text segments with substantially redundant content may be based on one or more criteria selected from the group consisting of: number of shared words, phrases, or minor variations on word phrases; frequencies of shared words, phrases, or minor variations on word phrases; percentage of shared words, phrases, or minor variations on word phrases; types of shared words, phrases, or minor variations on word phrases; order of shared words, phrases, or minor variations on word phrases; number of non-shared words, phrases, or minor variations on word phrases; frequencies of non-shared words, phrases, or minor variations on word phrases; percentage of non-shared words, phrases, or minor variations on word phrases; types of non-shared words, phrases, or minor variations on word phrases; order of non-shared words, phrases, or minor variations on word phrases; semantic analysis of content similarity; and Bayesian statistical analysis of content similarity.

The final step in the flow diagram in FIG. 1 involves synthesizing a single output document (107) from post-consolidation content from some, or all, of these sets of expanded text segments. This content is organized by set. The creation of a single synthesized document with information relevant to a search phrase, ordered by topic or sub-topic, can be more useful for the user than the output of current search engines, including discontinuous lists of links and source abstracts. In an example, each set of expanded text segments may be displayed as a paragraph in the document. In another example, there may be more than one set of expanded text segments in a single paragraph or text segments for a single set may be parsed into more than one paragraph in order to create paragraphs whose length is within a desired range.

In an example, the post-consolidation contents of all of the sets of expanded text segments may be included in the output document that is created by this method. In another example, only certain sets of expanded text segments may be selected to have their content included in the output document. In an example, there may be ordering criteria used to order the sets of text segments for inclusion in the output document. In various examples, these ordering criteria may include: ordering of seed phrases or expanded text segments in source documents; ranking of original sources; ranking of relevance of seed phrases; and lengths of seed phrases or expanded text segments.

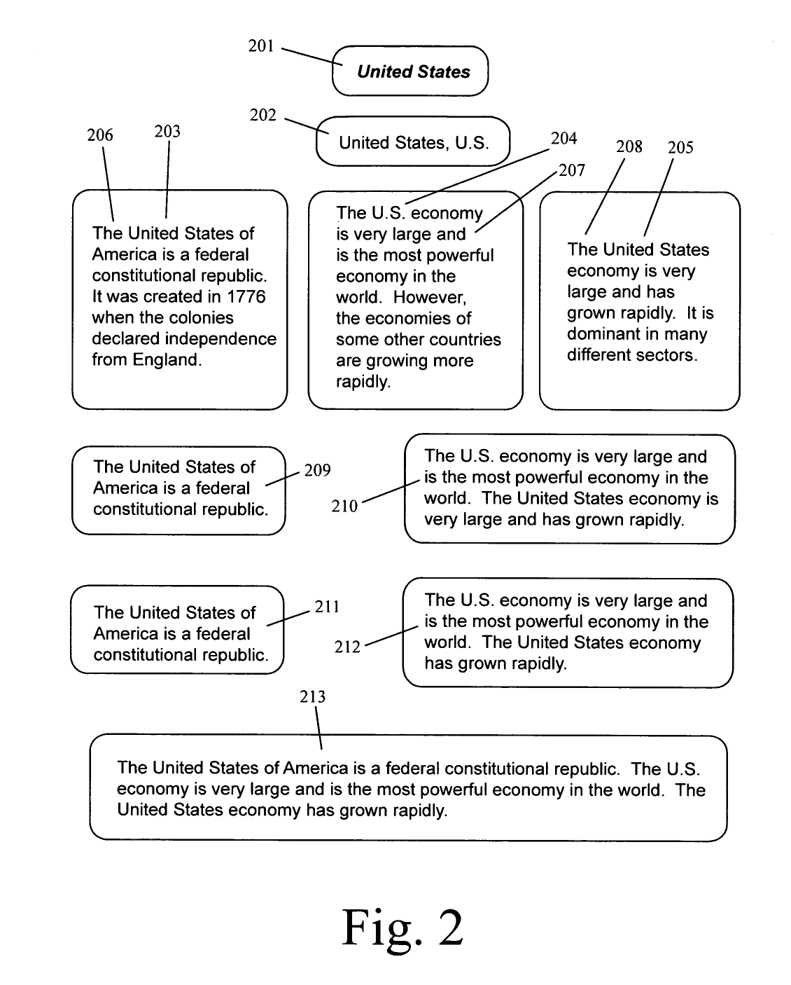

FIGS. 2 through 8 provide another perspective of one example of how this document-synthesizing search method might work. FIGS. 2 through 8 trace, in actual words, how this method can synthesize a document from multiple sources based on a user-provided search phrase. In the interest of diagrammatic simplicity, the example shown in FIGS. 2 through 8 is a very simple one. It involves only two seed phrases, only three sources, only three expanded text segments, only two sets of expanded text segments, and a synthesized document with only three sentences. In real life applications of this search method, there would likely be a large number of seed phrases, sources, expanded text segments, and sets of expanded text segments and the resulting output document could span a large number of pages.

The elements of all seven steps in this embodiment of the method are shown and labeled in FIG. 2, but each figure in FIGS. 2 through 8 progressively highlights a particular step in the seven-step sequence through the use of dotted-line arrows and bold/italicized text. For example, FIG. 2 highlights the first step in this method wherein a user provides the search phrase “United States” 201 which is highlighted in the diagram by the use of bold/italicized text.

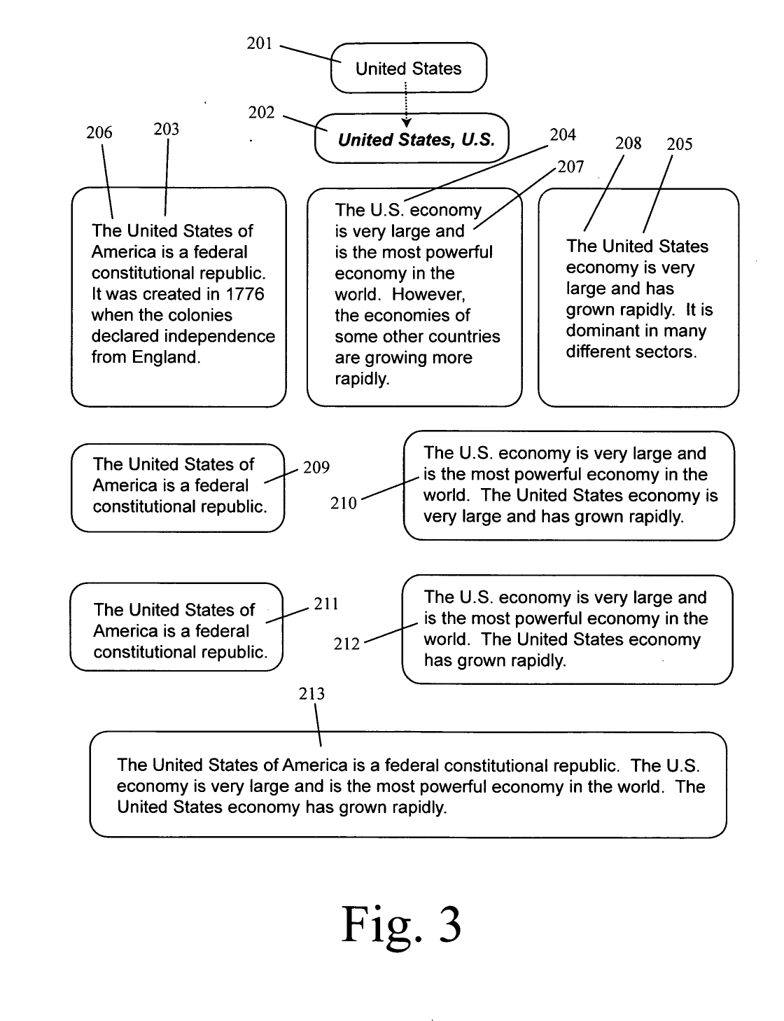

FIG. 3 highlights the second step in this embodiment of this search method wherein seed phrases 202 that are the same as, or minor variations of, the search phrase are created. In FIG. 3, the original search phrase “United States” and the minor variation (common abbreviation) “U.S.” are both seed phrases. In FIG. 3, they are both highlighted by the use of bold/italicized text. The dotted arrow from search phrase 201 to seed phrases 202 in FIG. 3 indicates that the search phrase 201 is used to create the seed phrases 202.

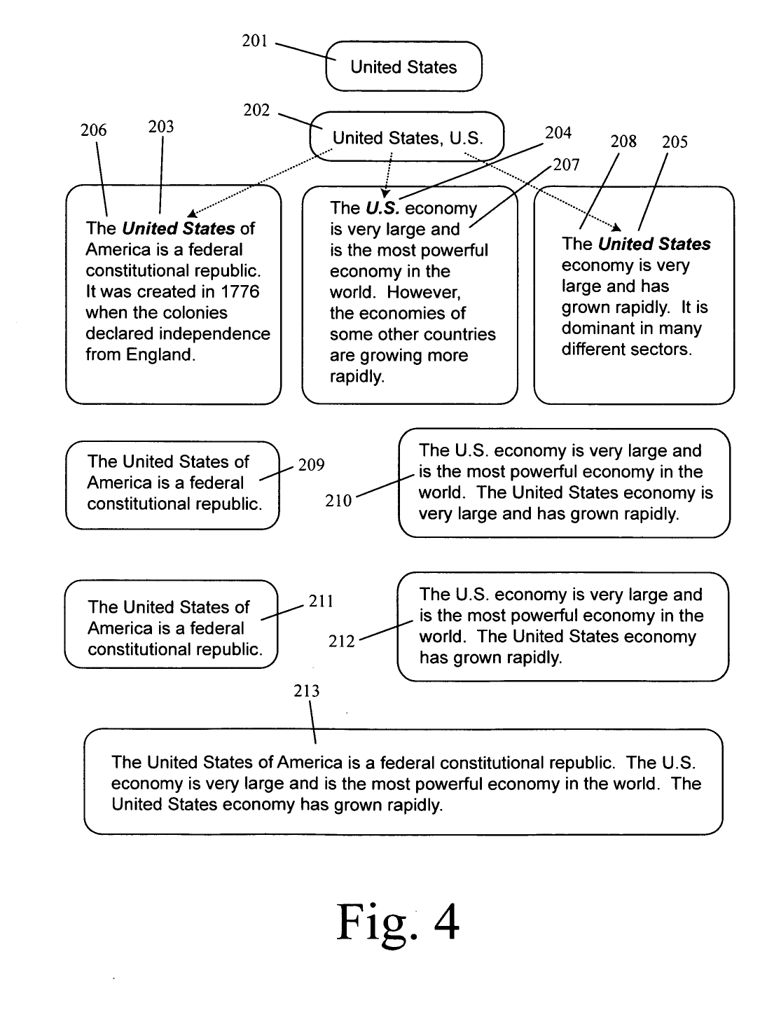

FIG. 4 highlights the third step in this embodiment of this search method wherein seed locations 203, 204, and 205 are found across multiple sources. A seed location is a location in a source where a seed phrase is found. In this example, seed locations 203, 204, and 205 are found in three sources and there is one seed location per source. In another example, there may be multiple seed locations in a single source. In FIG. 3, seed locations 203, 204, and 205 are highlighted by the use of bold/italicized text. The three dotted arrows from seed phrases 202 to seed locations 203, 204, and 205 indicate that seed phrases 202 are used to identify seed locations 203, 204, and 205.

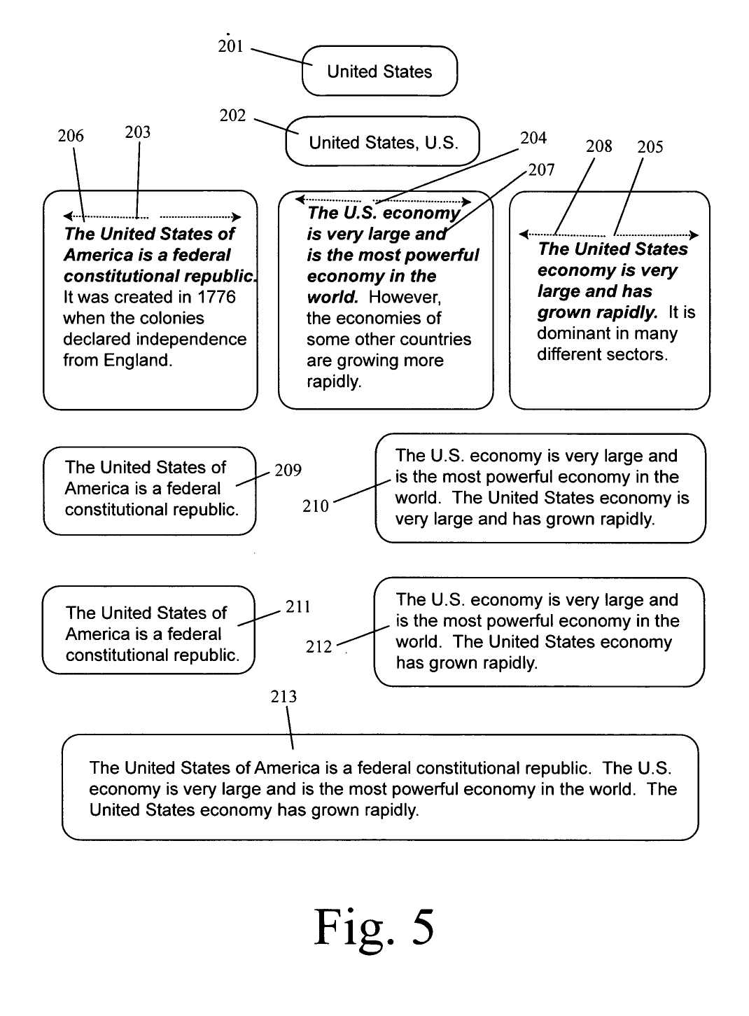

FIG. 5 highlights the fourth step in this embodiment of this search method. In this step, expanded text segments 206, 207, and 208 are created around the seed phrases in seed locations 203, 204, and 205, respectively. In this example, an expanded text segment extends backwards from a seed phrase to the beginning of the sentence in which the seed phrase is found and also extends forwards to the end of the sentence in which a seed phrase is found. For example, expanded text segment 206 is the sentence—“The United States of America is a federal constitutional republic.”—that contains the seed phrase—“United States”. As another example, expanded text segment 207 is the sentence—“The U.S. economy is very large and is the most powerful economy in the world.”—that contains the seed phrase “U.S.”.

In FIG. 5, expanded text segments 206, 207, and 208 are highlighted by use of bold/italicized text. The three pairs of horizontal arrows expanding outwards from seed phrases 203, 204, and 205 indicate the creation of the expanded text segments by backwards and forwards expansion of a text window around the seed phrases. In this example, this backwards and forwards expansion captures the entire sentence in which the seed phrase is found. As mentioned earlier in discussion of FIG. 1, there are other criteria that may be used to create expanded text segments in other examples of this method.

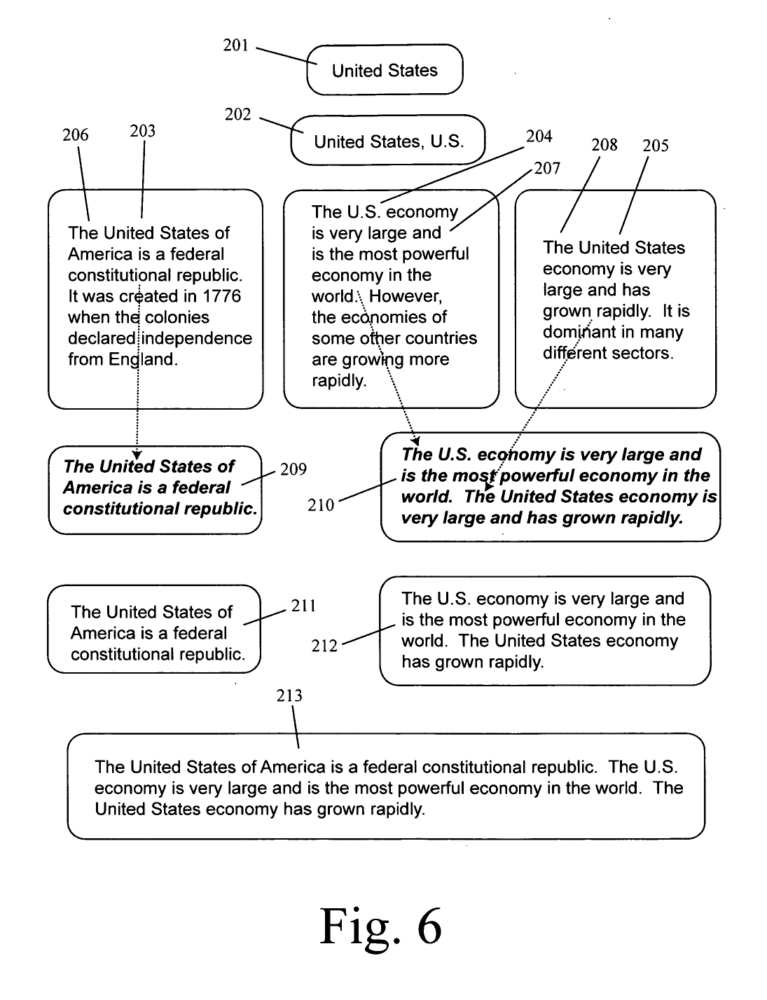

FIG. 6 highlights the fifth step in this embodiment of this search method. In this step, expanded text segments 206, 207, and 208 are grouped into sets of expanded text segments based on content similarity. In this example, two sets are formed. Set 209 focuses on the U.S. political structure and set 210 focuses on the U.S. economy. The contents of these sets are highlighted by the used of bold/italicized text. In FIG. 6, the three dotted-line arrows from expanded text segments 206, 207, and 208 to sets 209 and 210 indicate which expanded text segments are grouped into which sets. Expanded text segment 206 is grouped into set 209 and expanded text segments 207 and 208 are grouped into set 210. As discussed earlier concerning FIG. 1, in an example this grouping may be based on shared words or phrases among the expanded text segments. In this example, the word “economy” is shared by expanded text segments 207 and 208 and is the basis for their being grouped together into set 210.

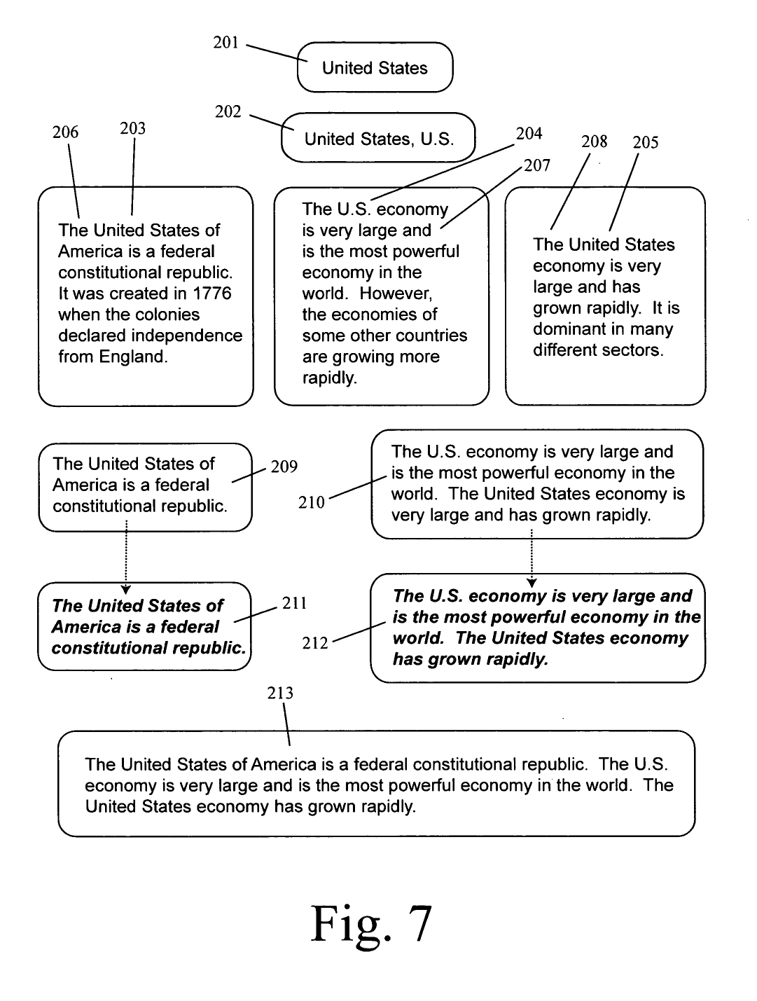

FIG. 7 highlights the sixth step in this embodiment. In this step, sets of expanded text segments may be consolidated and expanded text segments, or portions thereof, may be consolidated within sets. In this example, there is no consolidation of sets because the contents of sets 209 and 210 are not similar. However, there is content consolidation among portions of text segments within set 210 because the phrase “is very large” appears twice. One instance of this redundant phrase is consolidated (deleted in this example) in the post-consolidation content 212 of that set, as compared to pre-consolidation content 210 of that set.

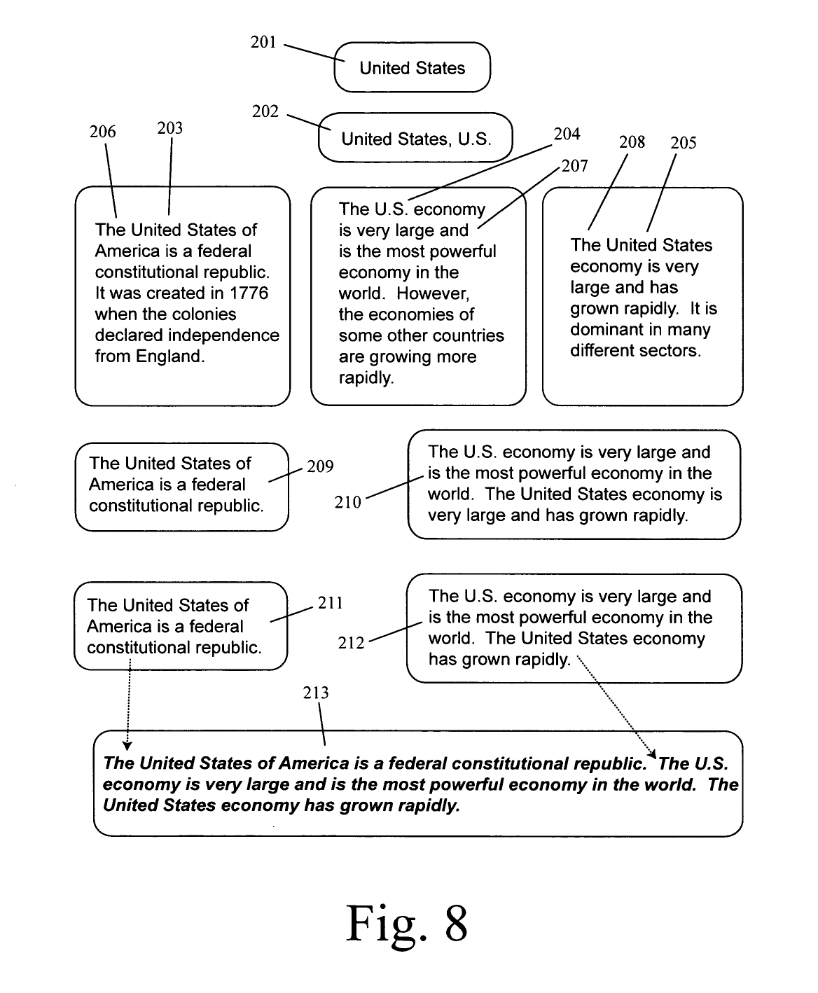

FIG. 8 highlights the last step in this embodiment. This final step results in the synthesis of a single output document 213 from post-consolidation content 211 and 212. This content is organized by set. The creation of a single synthesized document with information relevant to a search phrase, ordered by topic or sub-topic, can be more useful for the user than the output of current search engines, including discontinuous lists of links and source snippets. In this example, there are only two sets of expanded text segments 211 and 212 and both are used to create the output document. In another example, there may be a large number of sets of expanded'text segments and only certain sets may be selected for inclusion into the output document.

In the interest of diagrammatic and explanatory simplicity, this is a very simple example of how this search method might work. In this very simple example, the single output document 213 that results from the search term “United States” is a three-sentence paragraph that starts with a statement about the political structure of the U.S. and then provides two non-redundant statements about the U.S. economy. In more complex applications of this search method with the same search phrase, the resulting output document could have a large number of paragraphs, each focusing on a particular topic concerning the United States and integrating text segments from a large number of different sources. The creation of a single output document of this nature can be much more useful for a user than a list of links or source snippets that is neither integrated into a single narrative nor organized by topic.

I claim:

1. A search method and system that produces a document synthesized from multiple sources, comprising:
having a user provide a search phrase;
creating seed phrases, wherein a seed phrase can be the search phrase and also can be a minor variation on the search phrase;
identifying seed locations in multiple sources, wherein seed locations are locations where a seed phrase appears;
creating expanded text segments, wherein an expanded text segment is created for each seed location and each expanded text segment contains a seed phrase;
grouping expanded text segments, wherein expanded text segments are grouped into sets based on content similarity; and
synthesizing a document, wherein this document has content from some, or all, of these sets of expanded text segments and wherein this content is organized by set.

2. The user providing a search phrase in claim 1 wherein the method of this provision is selected from the group consisting of: typing a search phrase using a keyboard; entering a search phrase using a touch screen; selecting a search phrase from a menu of text phrases; selecting a search phrase associated with an icon; selecting a search phrase using a cursor; communicating a search phrase via gesture recognition; and providing a search phrase via speech.

3. The minor variations on the search phrase in claim 1 wherein one or more minor variations are selected from the group consisting of: a phrase with words that are corrected or alternative spelling variations of the words in the search phrase; a phrase with words that are grammatical variations (such as variation in tense, plurality, or voice) of the words comprising the search phrase; a phrase with words that are the same as those comprising the search phrase, except for the addition or deletion of grammatical articles (such as “a” or “an” or “the”) or relatively-neutral modifiers (such as “very” or “especially”); a phrase with words that are the same as those comprising the search phrase, but are in a different word order; a phrase with words that are the same as those comprising the search phrase, except for case variation (such as upper vs. lower case) in one or more letters in the search phrase; a phrase with the same words as those comprising the search phrase, but with variation in punctuation or word contraction; and a phrase that is a phrase synonym for the search phrase, wherein a phrase synonym is defined as alternative phrase that can be substituted for an original phrase in multiple sources without substantively changing meaning or creating a grammatical error in those sources.

4. The creation of expanded text segments in claim 1 wherein a text segment is defined using one or more definitions selected from the group including: (a) the expanded text segment includes characters spanning a first location, wherein this first location is a certain number of characters, words, sentences, or paragraphs backwards from the seed phrase, and a second location, wherein this second location is a certain number of characters, words, sentences, or paragraphs forwards from the seed phrase; (b) the expanded text segment includes characters spanning a first location, wherein this first location expands backwards from the seed phrase until stop criteria based on the length or content of the characters in this backwards expansion are satisfied, and a second location, wherein this second location expands forwards from the seed phrase until stop criteria based on the length or content of the characters in the forwards expansion are satisfied; and (c) the expanded text segment includes characters spanning a first location, wherein this first location expands backwards until one or more key characters or character strings are found, and a second location, wherein this second location expands forwards from the seed phrase until one or more key characters or character strings are found.

5. The grouping of expanded text segments in claim 1 wherein this grouping is done based on one or more criteria selected from the group consisting of: number of shared words, phrases, or minor variations on word phrases among expanded text segments; frequencies of shared words, phrases, or minor variations on word phrases among expanded text segments; percentage of shared words, phrases, or minor variations on word phrases among expanded text segments; types of shared words, phrases, or minor variations on word phrases among expanded text segments; order of shared words, phrases, or minor variations on word phrases among expanded text segments; number of non-shared words, phrases, or minor variations on word phrases among expanded text segments; frequencies of non-shared words, phrases, or minor variations on word phrases among expanded text segments; percentage of non-shared words, phrases, or minor variations on word phrases among expanded text segments; types of non-shared words, phrases, or minor variations on word phrases among expanded text segments; order of non-shared words, phrases, or minor variations on word phrases among expanded text segments; semantic analysis of content similarity among expanded text segments; and Bayesian statistical analysis of content similarity among expanded text segments.

6. A search method and system that produces a single document synthesized from multiple sources, comprising:
having a user provide a search phrase;
creating seed phrases, wherein a seed phrase can be the search phrase and also can be a minor variation on the search phrase;
identifying seed locations in multiple sources, wherein seed locations are locations where a seed phrase appears;
creating expanded text segments, wherein an expanded text segment is created for each seed location and each expanded text segment contains a seed phrase;
grouping expanded text segments, wherein expanded text segments are grouped into sets based on content similarity;
consolidating content, wherein sets with substantially redundant content are consolidated and wherein expanded text segments, or portions of expanded text segments, with substantially redundant content are consolidated; and
synthesizing a single document, wherein this single document has content from some, or all, of these sets of expanded text segments and wherein this content is organized by set.

7. The user providing a search phrase in claim 6 wherein the method of this provision is selected from the group consisting of: typing a search phrase using a keyboard; entering a search phrase using a touch screen; selecting a search phrase from a menu of text phrases; selecting a search phrase associated with an icon; selecting a search phrase using a cursor; communicatinga search phrase via gesture recognition; and providing a search phrase via speech.

8. The minor variations on the search phrase in claim 6 wherein one or more minor variations are selected from the group consisting of: a phrase with words that are corrected or alternative spelling variations of the words in the search phrase; a phrase with words that are grammatical variations (such as variation in tense, plurality, or voice) of the words comprising the search phrase; a phrase with words that are the same as those comprising the search phrase, except for the addition or deletion of grammatical articles (such as “a” or “an” or “the”) or relatively-neutral modifiers (such as “very” or “especially”); a phrase with words that are the same as those comprising the search phrase, but are in a different word order; a phrase with words that are the same as those comprising the search phrase, except for case variation (such as upper vs. lower case) in one or more letters in the search phrase; a phrase with the same words as those comprising the search phrase, but with variation in punctuation or word contraction; and a phrase that is a phrase synonym for the search phrase, wherein a phrase synonym is defined as alternative phrase that can be substituted for an original phrase in multiple sources without substantively changing meaning or creating a grammatical error in those sources.

9. The creation of expanded text segments in claim 6 wherein a text segment is defined using one or more definitions selected from the group including: (a) the expanded text segment includes characters spanning a first location, wherein this first location is a certain number of characters, words, sentences, or paragraphs backwards from the seed phrase, and a second location, wherein this second location is a certain number of characters, words, sentences, or paragraphs forwards from the seed phrase; (b) the expanded text segment includes characters spanning a first location, wherein this first location expands backwards from the seed phrase until stop criteria based on the length or content of the characters in this backwards expansion are satisfied, and a second location, wherein this second location expands forwards from the seed phrase until stop criteria based on the length or content of the characters in the forwards expansion are satisfied; and (c) the expanded text segment includes characters spanning a first location, wherein this first location expands backwards until one or more key characters or character strings are found, and a second location, wherein this second location expands forwards from the seed phrase until one or more key characters or character strings are found.

10. The grouping of expanded text segments in claim 6 wherein this grouping is done based on one or more criteria selected from the group consisting of: number of shared words, phrases, or minor variations on word phrases among expanded text segments; frequencies of shared words, phrases, or minor variations on word phrases among expanded text segments; percentage of shared words, phrases, or minor variations on word phrases among expanded text segments; types of shared words, phrases, or minor variations on word phrases among expanded text segments; order of shared words, phrases, or minor variations on word phrases among expanded text segments; number of non-shared words, phrases, or minor variations on word phrases among expanded text segments; frequencies of non-shared words, phrases, or minor variations on word phrases among expanded text segments; percentage of non-shared words, phrases, or minor variations on word phrases among expanded text segments; types of non-shared words, phrases, or minor variations on word phrases among expanded text segments; order of non-shared words, phrases, or minor variations on word phrases among expanded text segments; semantic analysis of content similarity among expanded text segments; and Bayesian statistical analysis of content similarity among expanded text segments.

11. The consolidation of content in claim 6 wherein identification of sets, expanded text segments, or portions of expanded text segments with substantially redundant content is based on one or more criteria selected from the group consisting of: number of shared words, phrases, or minor variations on word phrases; frequencies of shared words, phrases, or minor variations on word phrases; percentage of shared words, phrases, or minor variations on word phrases; types of shared words, phrases, or minor variations on word phrases; order of shared words, phrases, or minor variations on word phrases; number of non-shared words, phrases, or minor variations on word phrases; frequencies of non-shared words, phrases, or minor variations on word phrases; percentage of non-shared words, phrases, or minor variations on word phrases; types of non-shared words, phrases, or minor variations on word phrases; order of non-shared words, phrases, or minor variations on word phrases; semantic analysis of content similarity; and Bayesian statistical analysis of content similarity.

12. The synthesis of a single document in claim 6 wherein some, or all, of the post-consolidation sets of expanded text segments are selected for inclusion in the document and wherein the post-consolidation expanded text segments for those selected sets are grouped by set and included in the document.

13. A search method and system that produces a single document synthesized from multiple sources, comprising:
having a user provide a search phrase;
creating seed phrases, wherein seed phrases include the search phrase and also include minor variations on the search phrase, and wherein one or more minor variations are selected from the group consisting of: a phrase with words that are corrected or alternative spelling variations of the words in the search phrase; a phrase with words that are grammatical variations (such as variation in tense, plurality, or voice) of the words comprising the search phrase; a phrase with words that are the same as those comprising the search phrase, except for the addition or deletion of grammatical articles (such as “a” or “an” or “the”) or relatively-neutral modifiers (such as “very” or “especially”); a phrase with words that are the same as those comprising the search phrase, but are in a different word order; a phrase with words that are the same as those comprising the search phrase, except for case variation (such as upper vs. lower case) in one or more letters in the search phrase; a phrase with the same words as those comprising the search phrase, but with variation in punctuation or word contraction; and a phrase that is a phrase synonym for the search phrase, wherein a phrase synonym is defined as alternative phrase that can be substituted for an original phrase in multiple sources without substantively changing meaning or creating a grammatical error in those sources.
identifying seed locations in multiple sources, wherein seed locations are locations where a seed phrase appears;
creating expanded text segments, wherein an expanded text segment is created for each seed location and each expanded text segment contains a seed phrase, and wherein a text segment is defined using one or more definitions selected from the group including: (a) the expanded text segment includes characters spanning a first location, wherein this first location is a certain number of characters, words, sentences, or paragraphs backwards from the seed phrase, and a second location, wherein this second location is a certain number of characters, words, sentences, or paragraphs forwards from the seed phrase; (b) the expanded text segment includes characters spanning a first location, wherein this first location expands backwards from the seed phrase until stop criteria based on the length or content of the characters in this backwards expansion are satisfied, and a second location, wherein this second location expands forwards from the seed phrase until stop criteria based on the length or content of the characters in the forwards expansion are satisfied; and (c) the expanded text segment includes characters spanning a first location, wherein this first location expands backwards until one or more key characters or character strings are found, and a second location, wherein this second location expands forwards from the seed phrase until one or more key characters or character strings are found;
grouping expanded text segments, wherein expanded text segments are grouped into sets based on content similarity, and wherein this grouping is done based on one or more criteria selected from the group consisting of: number of shared words, phrases, or minor variations on word phrases among expanded text segments; frequencies of shared words, phrases, or minor variations on word phrases among expanded text segments; percentage of shared words, phrases, or minor variations on word phrases among expanded text segments; types of shared words, phrases, or minor variations on word phrases among expanded text segments; order of shared words, phrases, or minor variations on word phrases among expanded text segments; number of non-shared words, phrases, or minor variations on word phrases among expanded text segments; frequencies of non-shared words, phrases, or minor variations on word phrases among expanded text segments; percentage of non-shared words, phrases, or minor variations on word phrases among expanded text segments; types of non-shared words, phrases, or minor variations on word phrases among expanded text segments; order of non-shared words, phrases, or minor variations on word phrases among expanded text segments; semantic analysis of content similarity among expanded text segments; and Bayesian statistical analysis of content similarity among expanded text segments;
consolidating content, wherein sets with substantially redundant content are consolidated and wherein expanded text segments, or portions of expanded text segments, with substantially redundant content are consolidated; and wherein identification of sets, expanded text segments, or portions of expanded text segments with substantially redundant content is based on one or more criteria selected from the group consisting of: number of shared words, phrases, or minor variations on word phrases; frequencies of shared words, phrases, or minor variations on word phrases; percentage of shared words, phrases, or minor variations on word phrases; types of shared words, phrases, or minor variations on word phrases; order of shared words, phrases, or minor variations on word phrases; number of non-shared words, phrases, or minor variations on word phrases; frequencies of non-shared words, phrases, or minor variations on word phrases; percentage of non-shared words, phrases, or minor variations on word phrases; types of non-shared words, phrases, or minor variations on word phrases; order of non-shared words, phrases, or minor variations on word phrases; semantic analysis of content similarity; and Bayesian statistical analysis of content similarity;
and synthesizing a single document, wherein some, or all, of the post-consolidation sets of expanded text segments are selected for inclusion in the document and wherein the post-consolidation expanded text segments for those selected sets are grouped by set and included in the document.
